(19) United States
(12) Patent Application Publication
(10) Pub. No.: US 2006/0209848 A1
(43) Pub. Date: Sep. 21, 2006

(54) Method for the tranmission of buss ieee 1394 reinitialization messages and device for carrying out said method

(76) Inventors: Helmut Burklin, Rennes (FR); Nicolas Burdin, Rennes (FR); Sebastien Perrot, Rennes (FR)

Correspondence Address: THOMSON LICENSING INC., PATENT OPERATIONS, PO BOX 5312, PRINCETON, NJ, 08543-5312, US

(21) Appl. No.: 10/553,527

(22) PCT Filed: Apr. 1, 2004
(86) PCT No.: PCT/EP04/03469

§ 371 Date: Oct. 17, 2005

(30) Foreign Application Priority Data
Apr. 17, 2003 (FR) 03/04843

(51) Int. Cl. H04L 12/56

(52) U.S. Cl. 370/401

(57) ABSTRACT

The invention relates to a method of transmitting messages for resetting an IEEE 1394 bus and associated topology information, across a transparent bridge, a bridge head connected on the one hand to the 1394 bus and to the network affording the said transparent bridge, characterized in that, during a series of reset messages, the said bridge head selects the intermediate reset messages that it transmits to the other buses to which it is connected. This method being adapted, in particular, to the case where an intelligent method would be used for the phase of recognition of the network after the reconstruction of the topology at the time of a reset.

The present invention pertains to the field of communication networks, in particular of home network type, and relates more especially to a method of transmitting resets of the bus across a bridge.

The IEEE 1394 bus defined in the document “IEEE Std 1394-1995 High Performance Bus, 1996-08-30” describes a serial bus for digital transmission allowing the connection of devices also called “nodes”. This bus possesses the property of resetting itself regularly, a reset occurring when a new node is attached to the network or is detached and when for various reasons a node takes the initiative therefor. This mode of operation entails, from time to time, series of resets called a “bus reset storm”. A reset phase splits up into three main steps, the first consists in propagating a reset message proper which warns all the nodes of the reset involved. Subsequently, a calculation is done to re-allocate a unique physical address to each node, the base protocol serving for this calculation is described in Annex E, sections 3.1 to 3.3, of the standard cited. It consists, in a simplified manner, of tree traversal of “left right descending” type from an elected root, the numbering of the nodes being done sequentially, the parent being numbered after its children. This tree traversal is done by exchanging autoidentification packets (known as “self-id”), this whole set of autoidentification packets constituting what we call the “topology” of the network in the remainder of the document.

On completion of this phase, each node of the network has acquired its new address. It now remains for each node of the network to take cognisance of the new identity of each of the other nodes of the network, this being done by a phase of recognition in which each node will interrogate all the other nodes of the network. This recognition phase involving an interrogation of all the nodes of the network by all the nodes is therefore slow and generates traffic on the bus.

In a concern to improve the loading of the network, it is known to use an “intelligent” method improving this phase of recognition of the nodes of the network. Such a method is for example described in patent application EP 0 961 453 published on 1 Dec. 1999. The method described consists of a process for identifying nodes in a communication network, each node being furnished with at least one port for connection to the network, characterized in that it comprises the steps of:

allocating a first unique address to each node of the network according to a given process,

allocating a second unique address to each node of the network after a reset of the said network,

following a reset, establishing a correspondence table comprising the relation between the first and the second address of a node.

It is, moreover, possible to connect several buses by transparent bridges as for example wireless communication bridges has disclosed in patent application EP 1 246 400 published on 2 Oct. 2002. The concept of transparency being understood to mean the fact that the nodes of the network see a single virtual network composed of all the buses interconnected by the bridge. The bridge may be composed for example of a wireless network implementing the 802.11 standard or the HiperLAN2 standard, but it may also consist of any other type of network that is conceivable. To maintain the consistency of this virtual network between the various interconnected buses, it will be necessary to transmit the reset messages, which arise on one of the buses, to the other interconnected buses, as well as the associated autoidentification packets. Without this transmission, it would be impossible to maintain the topology of the unique virtual network on all the buses. The phase of construction of the topology of the network is followed, according to the standard, by a phase of recognition where each node of the network seeks to establish a correspondence between the EUID64 of the node and the physical identifier that was allocated to it. In the remainder of the document, we shall refer to a 1394 physical bus containing a bridge head as a “bus”, the other network connecting the bridge heads and allowing the interconnection of the buses as a “bridge” and the unique virtual bus consisting of the buses interconnected by the bridge has a “network”. The “bridge head” is the node of a bus which contains the two interfaces making it possible to connect the bus and the bridge.

In this case, the reset of the bus and also the traffic generated by the recognition phase induced are transmitted via the other network forming the bridge between the various buses. When a bridge head sees a reset on its local bus it transmits this reset, the topology (the whole set of autoidentification packets of the standard) associated with the other bridge heads, its peers, to which it is connected by the other network. These bridge heads then generate a reset on the bus to which they are connected. The recognition phase ensues, generating a great deal of traffic on the bridge. Moreover, the retransmission of this reset message will not be done immediately, therefore another reset may be observed on the local bus before the transmission of the message indicating the first reset. This is especially true when a reset storm occurs as mentioned above. That is to say when a reset series occurs.

This leads, on the one hand, to the storing of all these messages awaiting transmission together with the associated topology information on the bridge head. Moreover the transmission of all these messages causes a not inconsiderable loading on the bridge.

The aim of the invention is therefore to limit the number of reset messages transmitted by the bridge head to the other buses, without however compromising the topological integrity of the network, in particular during the use of an intelligent method limiting the recognition phase after reconstruction of the topology of the network.

The invention relates to a method of transmitting messages for resetting an IEEE 1394 bus and associated topology information, across a transparent bridge, a bridge head connected on the one hand to the 1394 bus and to the network affording the said transparent bridge, characterized in that, during a series of reset messages, the said bridge head selects the intermediate reset messages that it transmits to the other buses to which it is connected.

Although presented within the context of IEEE 1394 buses, it is clear that the invention may be applied to any type of bus, insofar as the latter possesses the characteristic of resetting itself and of recalculating its topology in a similar manner.

According to a first particular embodiment, the number of device connected to the bus is retained on each reset received by a bridge head. Thereafter, we look to see whether this number is increasing or decreasing and the reset is transmitted only in the case where this number was beginning to increase after having decreased or, conversely, was beginning to decrease after having increased.

According to a second particular embodiment, the bridge head stores the initial topology of the network. Subsequently, when it receives a reset message it calculates, in a known manner, a set of correspondence tables effecting the link between the addresses of the nodes before and after reset. These tables are obtained by a so-called “intelligent” method applied to the topology of the network before the reset and to the new topology resulting from the reset. Then the same method is applied to the initial topology and to the new topology. The comparison of the two results makes it possible to ascertain whether or not the intermediate resets may be disregarded without compromising this calculation of correspondence tables. In the case where this calculation is not compromised by the omission of the intermediate reset, the latter is omitted, it is not transmitted to the other buses.

According to a third particular embodiment of the invention, when a reset storm is triggered only two resets are transmitted. The first will simulate the disconnecting of the entire bus that is connected to the bridge head and responsible for the reset storm. The second, once the bus in question is in a stable state, will simulate the reconnecting of this bus and the transmission of its stabilized topology.

The invention operates regardless of the number of IEEE 1394 buses connected by a bridge since the method described is implemented on the bridge head of the bus responsible for the reset storm and is transparent to the other buses.

A subject of the invention is also a bridge head intended to link an IEEE 1394 bus and another network forming a bridge implementing a method of selective transmission of reset messages coming from the IEEE 1394 bus.

Other characteristics and advantages of the present invention will emerge from the description of the exemplary embodiment which follows, taken by way of non-limiting example, with reference to the appended figures in which:

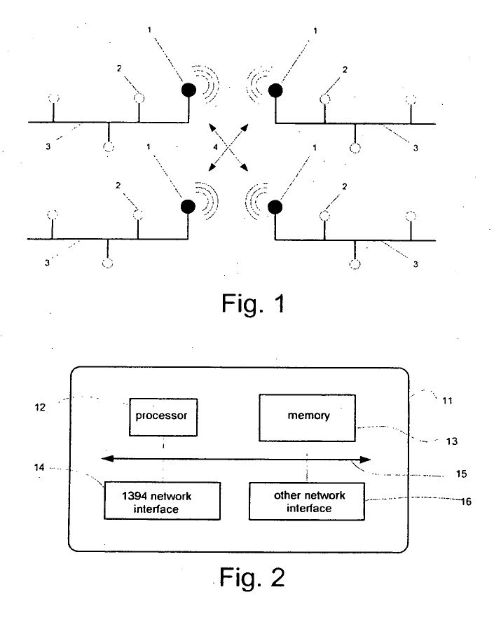

FIG. 1 is a diagram of a network where several IEEE 1394 buses are interconnected by way of a transparent bridge.

FIG. 2 diagrammatically represents the means implemented in a piece of equipment serving as bridge head between an IEEE 1394 bus and another network.

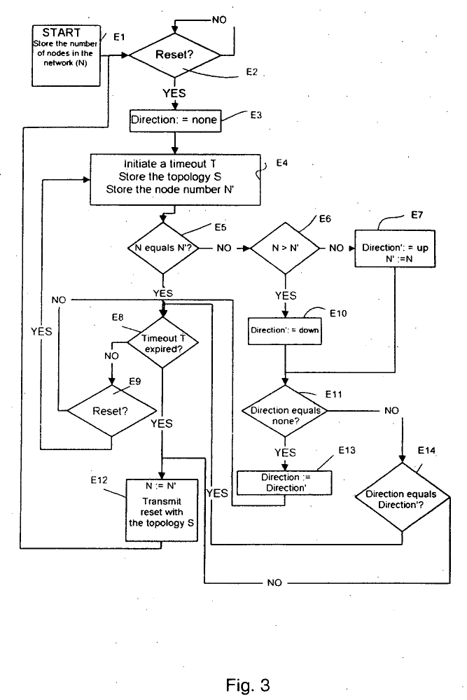

FIG. 3 represents, in the form of a flowchart, the first embodiment of the invention.

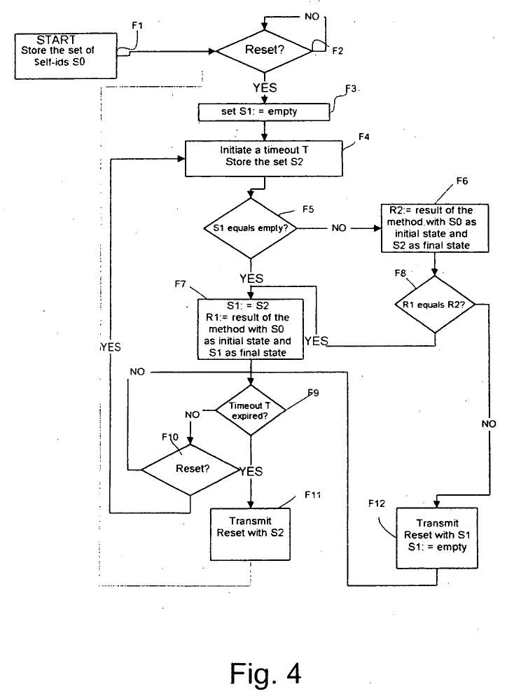

FIG. 4 represents, in the form of a flowchart, the second embodiment of the invention.

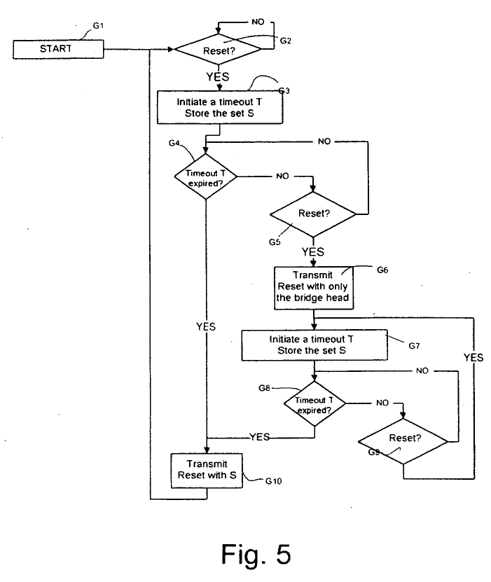

FIG. 5 represents, in the form of a flowchart, the third embodiment of the invention.

FIG. 1 represents a network composed of several 1394 buses interconnected by any other network (4). This other network may be a wireless network, such as for example an 802.11 or HiperLAN2 network, but it may also be based on any other technology. Each bus is composed of a 1394 link (3) connecting devices, called nodes (2). Each bus contains a bridge head (1) connected on the one hand to the 1394 bus and on the other hand to the other network (4). For the 1394 devices connected to a bus, the other network may be transparent, that is to say that in respect of these devices everything happens as if all the nodes of each of the buses were connected to the same physical 1394 network. The topology information stored in each node relates to the whole of the network in its entirety, it is not necessary for the information pertaining to this other network connecting the buses to be located on the nodes of the 1394 network.

FIG. 2 represents the general architecture of a bridge head (11). It consists of a memory (13) containing the programs implementing, among other things, the methods described in this invention, as well as the protocol stacks managing on the one hand the connection to the 1394 network and the other network. This memory (13) is connected to a processor (12) capable of executing these programs via a bus (15). Also connected to this bus are the physical network interfaces, 1394 (14) on the one hand and corresponding to the network (16) on the other hand.

When the problem arises of reducing the number of reset messages that have to be transmitted to the other buses of the network, such as described in FIG. 1, we immediately think of transmitting only the last message of a series of messages occurring in a short time interval. On condition that the corresponding topology information is transmitted, this simple method operates correctly in the case where the nodes implement the customary method described in the standard for topology calculation described in Annex E paragraph 3.2 of the standard cited.

However in the case of nodes implementing an intelligent topology calculation method such as that described in patent application EP 0 961 453, a simple application of this method leads to an incorrect calculation of the topology by the nodes situated on the other buses of the network. Specifically, this method is based on the fact that a node connected to a given port, after a reset of the network, either remains the same, or disappears, or appears. The possibility that it may be replaced with another node is not taken into account because it cannot happen in the case where all the resets of the network are dealt with. However, if we allow ourselves to omit resets, it may happen that a node is replaced by another and this replacement will not be taken into account, leading to an incorrect picture of the topology of the network.

The three exemplary embodiments of the invention, which will be described hereinbelow in greater detail, solve this problem and operate correctly whether the nodes perform recognition of the nodes after reset according to the customary method described in the standard or according to the intelligent method described in the aforesaid patent. These three examples must likewise adapt to many solutions other than the intelligent method described.

FIG. 3 describes a first embodiment of the invention compatible with the said intelligent method. In this embodiment, we begin by storing a number N of nodes in the bus connected to the bridge head (E1). An indicator of direction of the change in the number of nodes in the network will make it possible to store the fact that the number of nodes of the network is increasing or decreasing.

Thereafter we await the arrival of a reset message (E2).

When a first reset message is received, we mark the direction indicator with “none” (E3).

Then a timeout is instigated for a parametrizable duration T, this timeout making it possible to determine what is considered to be a storm of initialization messages.

The value of T is typically of the order of a millisecond, this representing eight 1394 cycles. It should be noted that if the value of the timeout parameter T is chosen to be too long the performance of the network will be penalized since the other buses will have to wait for at least this long to see the transmission of a reset coming from this bus. On the other hand, if T is chosen to be too short there is a risk of transmitting too many resets during a reset storm. This parameter will therefore have to be adjusted accordingly, this posing no particular problem to the person skilled in the art.

An alternative consists in waiting for the link to be free in order to transmit the reset message or for the previous reset message to have been acknowledged by the bridge head for which the message was intended or the bridge heads for which the message was intended.

The bus topology, communicated on the occasion of this reset, called S, is the set of autoidentification packets transmitted on the occasion of this reset as described in the standard cited. The new number of nodes of the bus N′ (E4) is also stored.

Here the question arises of ascertaining whether the number of nodes in the bus has altered (E5).

If this number has not altered, we look to see whether the timeout has expired (E8).

If this is the case, we modify the number of nodes of the bus by assigning it the new value N′, then we transmit the reset message and the new topology (E12), and we again stand by awaiting a new reset message (E2).

In the case where the timeout has not expired, we wait for it to expire or for a new reset message to arrive (E9). If it expires before the arrival of a new reset message, the message and the associated topology (E12) are transmitted as previously.

In the case where a new reset message arrives before the end of the timeout, it is processed like the previous message (E4).

Let us now return to what happens in the case where the number of nodes in the bus has altered (E6). The question arises of ascertaining whether this number is increasing or decreasing by setting a new direction index, Direction′, to “up” in the case where it is increasing and to “down” in the case where it is decreasing (E7, E10).

Next, the question arises of ascertaining whether the direction index previously stored was “none” and in this case we return to standby awaiting the timeout (E8).

If this previous direction index was already set, we look to see whether it is the same as the new index Direction′, if it is the same we again return to standby awaiting the timeout (E8), otherwise we transmit this reset and the associated topology to the other buses across the bridge (E12).

As may be seen this method leads to the transmission of only reset messages at a frequency T, plus the messages signalling alterations of direction in the changes in the number of nodes in the 1394 bus connected to the bridge head.

In a second particular embodiment, which is the preferred embodiment, illustrated by FIG. 4, the said intelligent method is used.

We begin by recording an initial topology of the bus connected to the bridge head, called S0 (F1).

Then we go on standby awaiting a reset message (F2).

On the arrival of a reset message, we initialize a bus topology S1 to “empty” (F3).

Thereafter we initiate a timeout with a time parameter T, and we store the topology transmitted on the occasion of this reset that we call S2 (F4).

In the case where S1 is empty, hence when the topology preceding the reset message processed is the initial topology, we record the new topology S2 as previous topology S1. Next we calculate the new content of the tables of correspondence between the addresses allocated to the nodes during the reset of the bus according to the method described in document EP 0 961 453, cited previously. The result of the said intelligent method applied to S0 as starting state and S1 as final state is called R1. This result is composed of three tables, the first giving the correspondence between the addresses allocated to the nodes, still present in the network, before and after reset, the second giving the addresses of the nodes that have disappeared from the network and the third the addresses of the nodes that have appeared in the network. R1 is therefore all of these three tables together.

Next we look to see whether the timeout has expired (F9), if this is the case we transmit the reset message together with the topology information S2 and we assign the initial topology S0 the value of S2 (F11). Otherwise we wait for the end of this timeout or the arrival of a new initialization message (F10) in which case we revert to processing this new message through a return to step F4.

In step F5, in the case where the previous topology S1 was not empty, we calculate the result R2 of the application of the said intelligent method by taking S0 as initial state and S2 as final state (F6) and we compare this result R2 with that obtained by taking S0 as initial state and S1 as final state that we stored in R1 (F8). The comparison therefore consists in comparing the content of the three tables obtained in the two cases. In the case where these two results are identical, we deduce therefrom that the intermediate topology S1 may not be transmitted without compromising the integrity of the network topology such as it will be seen on the various buses. We therefore go back to step F7, forgetting the intermediate topology. In the converse case, we are compelled to transmit this intermediate topology S1 before resetting the initial topology with this new value S1 and to go back to the start of the procedure at step F2, awaiting a new reset message (F12).

We therefore see that, in this exemplary embodiment, S0 still represents the topology such as it is seen by the other buses. While S1 represents a new intermediate topology calculated on the bus causing the reset, while on the arrival of a new reset S2 represents the new topology making it possible to compare the result of our intelligent method by taking account of the intermediate topology S1 and omitting it.

In a third embodiment of the invention, illustrated by FIG. 5, we shall describe a method making it possible to limit to two the number of reset messages arising during a reset storm.

To do this, we begin by standing by awaiting a first reset message (G2).

When this first message arrives, we initiate a timeout T and we store the topology transmitted S (G3).

We then look to see whether the timeout has expired (G4), and if so we transmit the reset accompanied by the topology S (G10).

If this timeout has not expired, we stand by awaiting its expiry or the arrival of a new reset (G5).

In the case where this new reset arises, we transmit it together with a calculated topology so as to signal only the presence of the bridge head (G6), then we reset the timeout T and we again store the topology S received with the reset (G7).

We then again go to a standby phase awaiting the expiry of the timeout or the arrival of a new reset (G8, G9).

This arrival of a new reset, before the expiry of the timeout causes the reset of the timeout and the storage of the last topology transmitted with this reset (G7).

When the timeout expires without reset, we transmit the last topology transmitted (G10).

It is therefore seen that this method amounts to simulating, for the other buses, the disconnecting of the whole of the bus causing the resets behind the bridge head, then the stabilized reconnecting of this bus after this storm.

Further information on the standards cited may be found in the following documents:
IEEE Std 1394-1995 High Performance Serial Bus
IEEE P1212 Draft 1.2, Control and Status Registers (CSR) Architecture for microcomputer buses

1. Method of transmitting messages for resetting a bus and associated topology information, across a transparent bridge, to other buses, connected to the first bus by the said bridge, connected on the one hand to the bus and on the other hand to the network affording the said transparent bridge, wherein, during a series of reset messages, the said bridge head selects the intermediate reset messages that it transmits to the other buses interconnected on the said bridge.

2. Method according to claim 1, wherein only the intermediate reset messages caused by an alteration in the direction of change of the number of nodes in the network are transmitted.

3. Method according to claim 2, further comprising the steps of:
storing the number of nodes of the bus connected to the bridge head and setting to zero an index of change of the number of nodes connected to the said bus,
on receipt of a reset message, comparing the new number of nodes connected to the said bus,
if the number of nodes does not alter, the reset message is not transmitted,
if the number of nodes is increasing whereas it was stable or was already increasing, the intermediate reset message is not transmitted,
if the number of nodes is decreasing whereas it was stable or was already decreasing, the intermediate reset message is not transmitted,
in other cases, the reset message is transmitted, then we return to the first step.

4. Method according to claim 1, the nodes of the network using a given method for the phase of recognition of the network after reset, wherein, the decision to transmit the reset, from the bus from which it originates to the other buses connected by the bridge, is taken as a function of the result of the application of the said method to the topology transmitted with the said reset.

5. Method according to claim 4, further comprising the steps of:
storing the initial topology of the bus connected;
on receipt of a reset, termed intermediate, storing of the associated topology without transmitting the said reset;
calculating and storing the result of the said intelligent method applied to the initial topology and to the new intermediate topology received;
on receipt of a new reset, calculating and storing the result of the said intelligent method applied to the initial topology and to the new topology received;
comparing the results given by the said intelligent method on the intermediate topology and the last one received;
transmitting the reset and the intermediate topology in the case of different results;
if the results are identical, the last topology becomes the intermediate topology;
a timeout ensuring the transmission of the last topology received after a given time.

6. Method according to claim 1, simulating the disconnecting of the entire bus generating the reset with the exception of the bridge head.

7. Method according to claim 6, further comprising the steps of:
on receipt of a first reset, transmitting this reset accompanied by topology information simulating the disconnecting of the bus behind the said bridge head;
thereafter, all the intermediate resets, except the last one, which arise in a given time are ignored, this timeout being reset with each receipt of a new reset message;
transmitting this last reset and associated topology information.

8. Method according to claim 1, wherein the buses are IEEE 1394 buses.

9. Device comprising a network interface connected to a bus and a network interface connected to another network, equipped with means of selective transmission of reset messages coming from the bus.

10. Device according to claim 9 where the bus is an IEEE 1394 bus.
